(19) United States
(12) Patent Application Publication
(10) Pub. No.: US 2024/0427309 A1
(43) Pub. Date: Dec. 26, 2024

(54) METHOD OF MANAGING 3D DIGITAL CONTENTS

(71) Applicant: SOULSHAPE S.R.L.S. SB, Arcevia (AN) (IT)

(72) Inventor: Pierpaolo CECILIANI, Arcevia (AN) (IT)

(21) Appl. No.: 18/690,331

(22) PCT Filed: Sep. 12, 2022
(86) PCT No.: PCT/IB2022/058571

§ 371 Date: Mar. 8, 2024

(30) Foreign Application Priority Data
Sep. 10, 2021 (IT) 102021000023480

(51) Int. Cl. G05B 19/4099

(52) U.S. Cl. CPC G05B 19/4099; G05B 2219/49023

(57) ABSTRACT

In a method of managing 3D digital content in a computer system, including a distributed server, a connection network to which the distributed server is connected, a plurality of client devices connected to the connection network and associated with respective users participating in the creation and modification of 3D digital content, starting from an initial 3D digital content, it is provided that, at the conclusion of a process of elaborating the final 3D digital content, the selling price and production cost of a product obtained from the final 3D digital content in a production process are computed, determining an added value and a share thereof to be distributed among the authors of the initial 3D digital content and of the layers added thereto; to then elaborate, for each author, a share percentage due based on management parameters obtainable from the tree structure of the cryptographic hashes assigned to each layer.

The object of the present invention is a method generally known as a computer implemented method (CI method), for managing 3D digital contents produced in successive steps by multiple users participating to the creation and editing thereof.

In modern digital design processes, digital contents are elaborated to be used to produce objects by means of three-dimensional additive printing, commonly known as 3D printing, or by means of other production processes of an industrial nature, with numerically controlled machine tools and other automatic or semi-automatic production devices, which transform the three-dimensional digital content, hereinafter referred to as 3D digital content, into a product.

The production of articles by means of additive printing represents an evolution of the so called Computer Aided Manufacturing, because designers elaborate, on computer systems, a file, possibly consisting of a stratification of modifications (layers) of an initial model, which is sent directly to a printing production process from which a finished product is obtained.

These planning and design processes generally start with a source digital content, which may be a first product model drawn up by a designer, a partial model of the product, a model taken from a computer library or a three-dimensional scan of an object that is used as a basis for the design process.

Thus, a plurality of users, qualified as designers in the production process, and identified as such in the management information system, may intervene on the source digital content, adding modifications to the source content, that may be seen as a series of layers overlapping the source digital content, possibly also modifying previously elaborated modifications, adding or removing parts and so on.

Each contribution consisting in any modification of the (N-1)th digital content produces an N-th layer, linked to a specific author.

This iterative and additive process therefore takes place with the participation of an indeterminate number of creators, each one qualified to intervene in the process as a designer.

Each passage through an individual user thus consists in a creative elaboration, whereby the individual user is entitled to participate as an author in the design of the final product, and in the associated industrial property rights.

It is also understood that this process of planning and design may be branched out: it may lead to the elaboration of intermediate models that, in turn, are modified by different users, thus generating a family of digital contents deriving from a source digital content.

Each creative contribution, and thus each layer, is characterised by an hourly dedication of the designer, which may be entitled to a specific hourly cost, depending on his/her technical and creative skills. The modification made may be of a different extent and may affect both the cost of the final product and its market value. In addition, each layer must also contain a timestamp that creates a chronological order of the modifications.

The cost of the final product will schematically depend on the duration of the production process, the cost of the production devices used, which will be identified by a specific amortisation cost, the cost of the material or materials used to manufacture the product, and other parameters that take into account transport, storage, the cost of production facilities, and so on.

The production cost, in an industrial context, is also affected by the amount of products to be manufactured starting from the same 3D digital content: generally, the larger this amount, the lower the production cost of the individual item.

The market value, on the other hand, is the price at which the product is sold to an end user; it will depend on multiple market variables, and will not only have to cover production costs, but also ensure a profit for the producer and authors of the final 3D digital content that has been used as a manufacturing model, a profit that is identified by a share of the so-called added value of the product, i.e. the difference between the selling price and the production cost.

This share thus determines the monetisation of an entire chain represented by the added economic value of 3D digital contents, starting with the step of uploading the source 3D digital content.

Such share must be equally allocated between the authors who provided the source digital content and who participated with their creative contributions, allocating financial rewards directed to the owners of the source digital content and the subsequent authors.

However, considering that modifications may occur at different times and on different systems, in a distributed and non-centralised design model, in order to achieve such an allocation it is necessary to review, each time, the final digital content, compare it with the initial model and make estimates to compute the shares to be assigned to the different authors, a process which is extremely complex, time-consuming, and rarely succeeds in taking into account all the variables. Therefore, this methodology is not free from possible criticism and is not reliable.

The technical problem underlying the present invention is to provide a method for managing 3D digital contents that allows to overcome the drawback mentioned referring to the prior art.

Such a problem is solved by a method for managing 3D digital contents preferably performed by means of a computer system which preferably comprises at least one distributed server, a connection network to which said distributed server is connected, a plurality of client devices connected to said connection network and associated with respective users participating in the creation and editing of a 3D digital content, starting from an initial 3D digital content.

Preferably, the method provides to upload an initial 3D digital content into that distributed server, to which a corresponding timestamp is applied.

Preferably, the method comprises identifying, as authors, a set of users qualified to modify said initial 3D digital content, by means of data defining the respective user identity.

Preferably generating, in a process of elaborating a final 3D digital content, a plurality of modification layers from the initial 3D digital content, each N-th layer produced by one or more authors of said set of users and provided with a relative timestamp determining a chronological order thereof.

The method preferably provides computing, for each N-th layer that is generated, an index representative of the creative contribution of the respective author preferably based on one or more of the following: size of the layer, time taken to generate it, at least one rating based on the complexity of the layer.

Preferably, for each N-th layer, collecting the management parameters of the layer which include: the associated timestamp, a pointer linking it to a 3D digital content that has been modified by the layer, an identification of the author of the layer, and said index of creative contribution.

Preferably, the method provides, for each generated N-th layer, assigning said management parameters to a file comprising the modified 3D digital content with all layers 1 to (N-1)th, together with an encoding of the N-th layer and the management parameters obtained according to a unique cryptographic code, that produces a cryptographic hash which is recorded in at least one distributed public ledger according to the blockchain technology, producing a tree structure together with the cryptographic hashes of layers from 1 to (N-1)th;

Preferably at the conclusion of the aforementioned process, computing the selling price and the production cost of a product obtained from the final 3D digital content in a production process, determining an added value and a share thereof to be distributed among the authors of the initial 3D digital content and of the layers added to it.

Preferably elaborating, for each author, a percentage of due share based on the management parameters obtainable from the tree structure of cryptographic hashes assigned to each layer.

In the method according to the invention, an initial 3D digital content is firstly loaded into a computer management system: it is made available in a distributed computer system, which comprises at least one server with a processor and a storage wherein the initial content and the following modifications are stored, each with a corresponding timestamp.

This system is accessible to a set of users who are enabled to modify the 3D digital content by introducing a layer that is linked to its author; users are identified in the system, although their identity may not be accessible to other users.

Each layer from 1 to N is thus distinguished by a timestamp, a pointer linking it to a 3D digital content that has been modified, an identification of the author of the layer and a layer index that is representative of the creative contribution of the author.

The creative contribution may be computed on the basis of various parameters, which comprise the time spent elaborating the layer and possibly an initial assessment (rating) of the author, which for example may be representative of his or her hourly wage, agreed upon with the system operators. In addition, such index could also contain a second assessment (rating) that is representative of the importance, weight of the modification made with the layer: this second assessment could be the result of a self-assessment by the author himself, or it could be assigned by a panel of authors, or it could be assigned by the system operators.

For each layer, the timestamp, the pointer, the author identification, and the index of the layer constitute the management parameters of the layer. They are assigned to the file containing the initial digital content and the layer forming a set that is encoded to obtain a cryptographic hash, with an appropriate computing algorithm, which is recorded in at least one public ledger, according to the blockchain technology.

Once the modification process with successive layers has reached a mature stage, it produces a final 3D digital content that may be used in a production process to obtain a product to be placed on the market at a certain selling price, from which, computing the production cost by examining the final 3D digital content, it is possible to compute the respective added value and the share to address to the authors.

The computer system is thus able to take into account both the initial 3D digital content and all the layers that determined the final 3D digital content, with the respective hash verifiable through a distributed public ledger, which in turn authenticates the management parameters of each layer.

Once this verification has been made, the computer system, by means of its own processor, uses the aforementioned management parameters to compute the share percentages due to all the authors who have contributed to the final 3D digital content, so that the proceeds, once collected, may be addressed by the system to their respective destinations.

The decentralised blockchain architecture described above is used for each 3D digital file to track the possibly anonymised identities of the uploader of the original digital content used as the basis, and those of each editor, and the percentages of variable value attributable to subsequent modifications with respect to the added value.

The management method and the computer system implementing it thus enable the monetisation of an entire 3D digital content value chain starting from the original 3D content uploaded, with the subsequent modifications, making it possible to properly allocate economic rewards among the users who participated in the creative process.

In general, the technology described herein is directed to systems and methods for storing the original job data on a blockchain of data concerning the layers of the final 3D digital content, also to verify that they derive from the source 3D digital content, preserving the proof data proving that the derived job indeed derives from the original content. All data of the layers are verified as such, and are added to the blockchain in such a way as to make them reliable, transparent and traceable.

The present invention will be hereinafter described according to a preferred embodiment thereof, provided for exemplary and non-limiting purposes with reference to the accompanying drawings wherein:

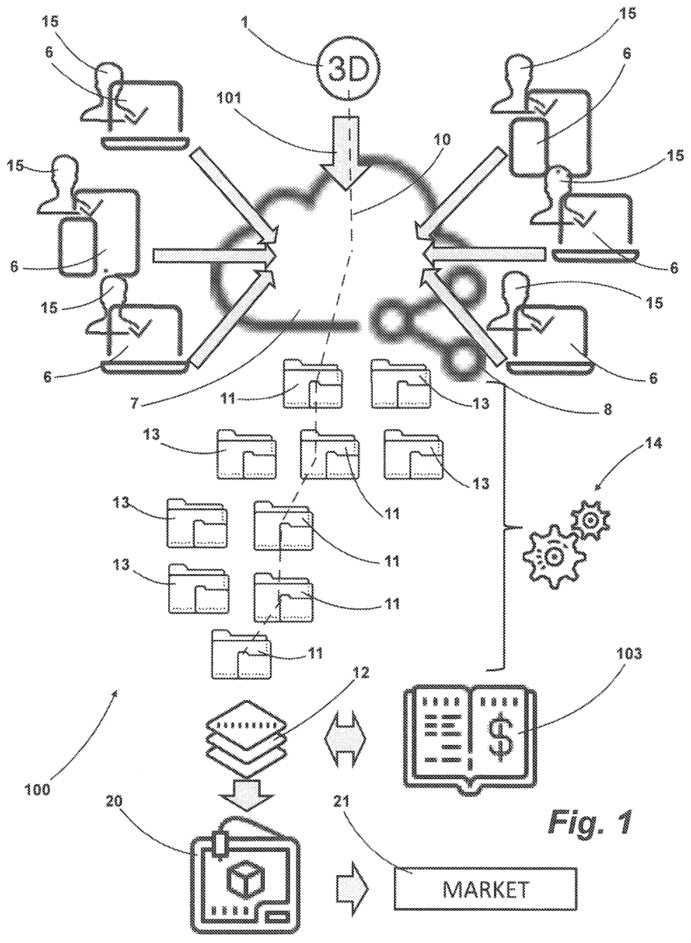

FIG. 1 shows a first diagram illustrating an embodiment of the method of managing 3D digital contents according to the invention, in a computer system;

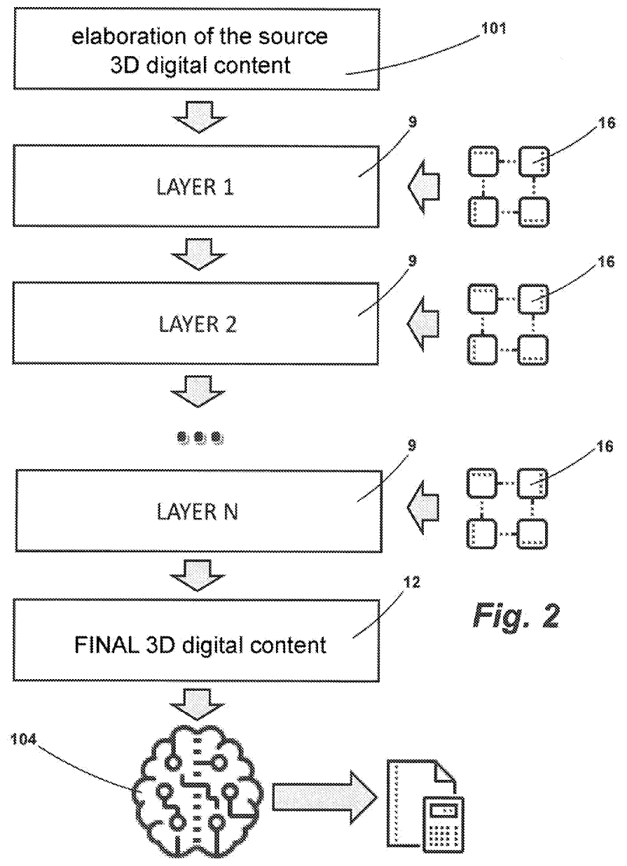

FIG. 2 shows a second diagram illustrating the designing process and the determination of the share of added value to be allocated to each author; and

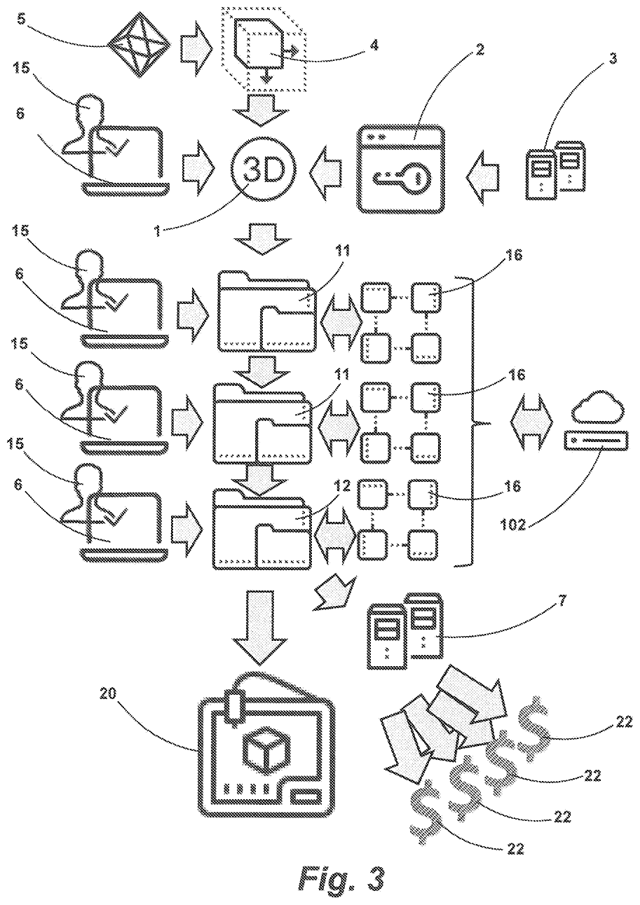

FIG. 3 shows a third diagram illustrating both the designing process, with the determination of the share of added value to be allocated to each author, and the production process associated thereto.

The present disclosure should be regarded as an exemplification of the invention and is not intended to limit the invention to the specific embodiments illustrated by the figures or the hereinafter description.

It is implemented in an IT platform comprising a computer system, globally referred to as 100.

In the following description, the term “blockchain” generally refers to a distributed database containing a register or list of records, called blocks, which are protected from tampering and revision by a unique cryptographic hash code; they correspond to a set of data assigned to each layer forming a 3D digital content.

Every time data are published on a blockchain database, data may be published as a new block. Each block may include a timestamp and a pointer to a previous block. Through the use of a peer-to-peer network and a distributed timestamp server, a blockchain database may be managed completely autonomously.

Blockchains constitute an open and distributed “ledger”, capable of recording data corresponding to the above-mentioned layers in an efficient, verifiable and permanent manner. The consent to use this encoding methodology ensures that distributed records are exact copies, and reduces the risk of fraudulent transactions, as tampering may have to occur in many places at exactly the same time.

Cryptographic hashes, e.g. obtained through an encryption algorithm of the SHA2-type, such as SHA256 or equivalent, or possibly 3- or subsequent, ensure that any alteration of the input results in computing a different hash value, which would indicate a potentially compromised input.

Hashes may be assigned by a digital signature mechanism that ensures that inputs originate from users recognised by the system, and not impostors.

Inside it, a blockchain computer system records the chronological order of inputs, assigning them a respective timestamp, with all nodes in the system accepting the validity of the input using the chosen consent model. The result is an irreversible identification accepted by all partners of the computer system.

3D digital content refers to a file or set of files elaborated using specific three-dimensional modelling software. The 3D digital content may be elaborated from an initial 3D digital content 1, which is loaded into the computer system 100. Such an uploading 101 may refer to an initial 3D digital content that has been elaborated by one or more authors, and it is assigned respective management parameters, comprising a timestamp, which will be described below, along with an initial cryptographic hash 2. It may also be taken from a computer library 3 of distributed digital contents.

Alternatively, the initial 3D digital content 1 may be obtained by a 3D scanning process carried out by a 3D scanner 4 from a physical model 5 (FIG. 3).

An illustrative example of some of the physical components that may comprise a computer platform comprising the computer system 100 for managing 3D digital contents using a blockchain, identified in short as system, which is configured to facilitate the transfer of data and information between one or more access points, client devices 6 and servers 7 on a data network.

Each client device 6 may send data and receive data from the data network via a network connection with an access point. A data storage accessible from server 7 may contain one or more databases. Data may comprise any information relevant to one or more users entered into the system including information about or describing one or more users, information about or describing one or more pieces of digital content, such as title, author, ownership information, timestamps, any licence and royalty requirements for collaboration, and a possible nonce, i.e. a number, usually random or pseudo-random, that has a unique use.

The system 100 comprises at least one client device 6, but preferably more than two client devices 6, configured to be managed by one or more users. The client devices 6 may be mobile devices, such as laptops, tablets, personal digital assistants, smartphones and the like, provided with a wireless network interface capable of sending data to one or more servers having access to one or more data storages on a network such as a wireless local area network (WLAN). Furthermore, the client devices 6 may be stationary devices, such as desktops, workstations and the like, provided with a wireless or wired network interface capable of sending data to one or more servers having access to one or more data storages via a wireless network or wired local area network.

The present invention may be implemented on at least one client device 6 and/or server device 7 programmed to execute one or more of the steps described herein.

In some embodiments, it is possible to use more than one client 6 and/or server device 7, each programmed to execute one or more steps of a method or process described herein.

The client device 6 may be a digital device that, in terms of hardware architecture, generally includes a processor, input/output (I/O) interfaces, a radio, a data storage and a memory.

The server 7 may be a digital computer that, in terms of hardware architecture, generally includes a processor, input/output (I/O) interfaces, a network interface, a data storage and a memory.

In general, the server processor or client device is a hardware device for executing software instructions. The processor may be any customised or commercially available processor, a central processing unit (CPU), an auxiliary processor between several processors associated with the device, a semiconductor-based microprocessor (in the form of a microchip or chip set) or generally any device for executing software instructions. When the server and client device are in operation, the processor is configured to execute the software stored in the memory, to communicate data to and from the memory, and to generally control server operations according to software instructions. I/O interfaces may be used to receive the user input from and/or to provide the system output to one or more devices or components.

The user input may be provided via, for example, a keyboard, touch pad and/or mouse. Then system output may be provided via a display device and a printer (not shown). I/O interfaces may include, for example, a serial port, a parallel port, a Small Computer System Interface (SCSI), a Serial ATA (SATA), a Fibre Channel, isCSI, a PCI Express (PCI-x) interface, an Infrared (IR) interface, a Radio Frequency (RF) interface and/or a Universal Serial Bus (USB) interface and evolutions thereof, and generally any other interface for digital data transmission.

The network interface may be used to enable the server to communicate over a network, such as the Internet, a wide area network (WAN), a local area network (LAN) and the like. The network interface may include, for example, an Ethernet card or adapter, or a wireless local area network card or adapter (e.g. 802.11a/b/g/n). The network interface may include addresses, control and/or data connections to enable appropriate communications on the network. A data storage may be used to store data. The data storage may include any volatile memory element (e.g. random access memory (RAM, such as DRAM, SRAM, SDRAM and the like)), non-volatile memory elements (e.g. ROM, hard disk, tape, CDROM and the like) and combinations thereof. Furthermore, the data storage may incorporate electronic, magnetic, optical and/or other storage means. In one example, the data storage may be located within the server as, for instance, an internal hard drive connected to the local interface in the server. Furthermore, in another embodiment, the data storage may be positioned outside the server, such as an external hard drive connected to the I/O interfaces. In a further embodiment, the data storage may be connected to the server via a network, such as a file server connected to the network.

Note that the memory may have a distributed architecture, otherwise known as the cloud, wherein various components are located remote from each other, but may be reached by the processor. The software in the memory may include one or more software programmes, each of which includes an ordered list of executable instructions for implementing logical functions. The software in the memory includes a suitable operating system (O/S) and one or more programmes. The operating system essentially controls the execution of other computer programmes, such as one or more programmes, and provides scheduling, input-output control, file and data management, memory management and communication control and related services. The one or more programmes may be configured to implement the various processes, algorithms, methods, techniques, etc. herein described.

The computer system 100 comprises a connection to a blockchain network 102, having one or more nodes, which may be in communication with one or more servers 7 and/or client devices 6 of the system 100. A node may consist of a server, a client device or appropriate networked elaboration any other platform. The blockchain network 102 may manage a distributed blockchain database 103 containing the data recorded by the system. These data may be maintained as a distributed public ledger, which can be referred to as blocks, protected from tampering and revisions.

In general, each block includes a timestamp and a link to a previous block. Through the use of a peer-to-peer blockchain network 102 and a distributed timestamping server, a distributed public ledger may be managed autonomously. This ensures that distributed records are exact copies and reduces the risk of fraudulent operations, as tampering may have to occur in many places at exactly the same time.

Cryptographic hashes, obtained through a specific cryptographic calculation algorithm, such as SHA256, ensure that any alteration of the data input results in computing a different hash value, indicating a potentially compromised transaction input.

Digital signatures may also be provided to ensure that data input transactions originate from users (signed with private keys) who are part of a specific group, in the particular case a group of users identifiable as authors and qualified to act on a 3D digital content of the system.

In addition, the distributed public ledger may record the chronological order of data entry with all nodes accepting the validity of entry transactions using a chosen and shared consent model.

The blockchain network 102 may include a cryptocurrency or other digital resource designed to function as a means of exchange that uses cryptography to protect its transactions, to control the creation of additional units and to verify the transfer of resources. The example cryptocurrencies include Bitcoin, Etherium, Ripple, etc.

The computer system 100 provides users, owners and creators, with a highly secure central data repository that may be distributed between participants on a basis established by the system operators, or distributed by the users themselves. The information generated and used in the elaboration process may thus be distributed among users in order to create a 3D digital content obtained by modifying the initial 3D digital content 1, each time by inserting additions, modifications or deletions that result in a layer 9 that is temporally marked in a chronological order, so that a layer 1, a layer 2 and so on will be produced, up to a layer N (FIG. 2), i.e. the last of the set of modifications in an elaboration process 10 that, at each step, produces an intermediate 3D digital content 11, and the 3D digital content obtained with the last layer of such succession is identifiable as the final 3D digital content 12.

This elaboration process could branch out into a broader collaborative process 14 consisting of several levels, at which alternative 3D digital contents may be produced, which undergo the same treatment as the intermediate 3D digital content 11.

The computer system 100 may also be configured to allow a set of processes related to three-dimensional graphics elaboration to be promoted up to completion: for example, providing an underlying intelligence system that collects metrics of these processes and provides both workflow support, to improve the quality and speed of collaboration within and between groups or businesses, and analysis of these metrics, to provide data for system optimisation, and to allow these metrics to be tracked and viewed in graphical dashboards and through a workflow monitoring system. This enables the management by a company or ecosystem to monitor, view and optimise the elaboration process within the system they are required to manage.

Access to the blockchain content of intermediate or alternative 3D digital contents 11, 13 may be managed in various ways. For maximum transparency and access, the blockchain of intermediate or alternative 3D digital contents 11, 13 may be started on a public blockchain with the data available to anyone entitled to access the blockchain. Or the blockchain of intermediate or alternative 3D digital contents 11, 13 may be configured to encrypt the initial 3D digital content 1 or intermediate or alternative 3D digital contents 11, 13 to limit the access so that each step is strictly controlled. For example, only selected and identified users may access the blockchain of intermediate or alternative 3D digital contents 11, 13.

With the IT platform comprising the IT system 100 described above, it is possible to provide that the method of managing 3D digital content includes a step wherein a set of users, qualified to modify said initial 3D digital content 1 are identified as authors 15 in the collaboration process 14, or in general for the IT system 100.

The identification, i.e. the authentication of the respective identity, can take place by means of data defining the respective identity of users, such as data of an electronic signature associated with the author.

Once the platform users are defined as authors with reference to a specific initial 3D digital content 1, the authors, in the elaboration process leading to the final 3D digital content 12, generate a plurality of modification layers 9 from the initial 3D digital content 1.

Each N-th layer 9, which is generated by one or more authors of said set and which is then entered into the system 100, is provided with a relative timestamp that determines a chronological order thereof.

Starting from the available data, for each N-th layer that is generated, a representative index of the creative contribution of the respective author 15 is calculated on the basis of, in the first instance, the size of the layer produced, the time used to generate it and at least one rating based on the complexity of the layer.

The size of the produced layer is an objective amount that expresses a dimension associated with the generated layer; it may be expressed as the amount of memory used in the process of elaborating the layer, or an amount that expresses the use of the client device resources 6 and/or of the network resources used.

Such size may be computed by a special counter that is activated at the beginning of the creative process. Similarly, a timer may measure the time taken by the author to process the layer, which can take into account intermediate periods of inactivity, i.e. breaks and interruptions.

Among the data forming the rating, one piece of data that may be interesting to include is an hourly wage of each author, not for the purpose of offering the author an hourly wage but as an index of his skill, experience and so on. This is equivalent to any data that can express this magnitude, and may be agreed upon between the platform operator and the author himself.

In addition, the rating may comprise a self-assessment by the respective author 15 who can express the level of complexity of the work done and the difficulties overcome.

The rating could also include additional assessments, assigned by a panel of authors or external experts, or still assigned by the system operators.

The following data: the timestamp, a pointer linking it to a 3D digital content that has been modified by the layer, an identification of the author of the layer, and the index of creative contribution described above are used to define the respective management parameters for each N-th layer.

They, still for each generated N-th layer, are assigned to a file comprising the modified, i.e. intermediate or alternative, 3D digital content with all the layers 1 to (N-1)th forming it, together with an encoding of the N-th layer and management parameters obtained according to a unique cryptographic code, which produces a cryptographic hash 16 that is recorded in said distributed public ledger 102, according to the blockchain technology described above, so as to produce, together with the hashes of layers 1 to (N-1)th, a tree structure, typically a Markle tree.

Once the elaboration process 10 has concluded generating the final 3D digital content 12, the latter may be used in a production process for manufacturing the relevant product, which in the present example comprises a 3D additive printing process employing at least one 3D printer referred to as 20 (FIGS. 1 and 3).

It is understood that, in alternative, another production process of an industrial nature may be used, with numerically controlled machine tools and other automatic or semi-automatic production devices, which transform the final 3D digital content 12 into a product that is launched onto the market 21.

At this step, the selling price and the production cost of the product are computed, thus determining an added value and a share thereof that is intended to be assigned to the different authors who participated in the elaboration process 10, based on the contribution of each one, thus taking into account all the management parameters that the final 3D digital content 12 has accumulated during the elaboration process 10.

Thus, the management method comprises the step of elaborating, for each author, a percentage of the share 22 due based on the management parameters obtainable from the tree structure of the cryptographic hashes 16 assigned to each layer 9.

In a preferred embodiment of the present method, this step of elaborating the percentage of the share due to each author 15 is carried out by means of an artificial intelligence algorithm 104, set up in the system 100.

Once the proceeds related to the selling of the products are collected, the share percentages 22 due to the authors 15 is addressed to them as an economic reward, in the form of real or virtual currency.

In describing the present invention, techniques and steps involving specific advantages have been described. Therefore, for the sake of clarity, any possible combination of the individual steps will not be repeated in a redundant manner. However, the description and claims should be read considering that such combinations entirely fall within the scope of the invention and the claims.

In addition, in the present description, new computer-implemented systems and methods for elaborating data, rights and transactions related to 3D digital contents have been discussed. In the following description, for the purpose of explanation, several specific details are given in order to provide a complete understanding of the present invention. It will be clear, however, to the person skilled in the art that the present invention may be put into practice without these specific details.

A person skilled in the art, in order to meet further and contingent requirements, may make several further modifications and variations to the above-described management method, all of which, however, fall within the scope of protection of the present invention as defined by the appended claims.

1. Method of managing 3D digital contents in a computer system including at least one distributed server, a connection network to which said shared server is connected, a plurality of client devices connected to said connection network and associated with respective users participating to the creation and the editing of a 3D digital content, starting from an initial 3D digital content, including the steps of:
uploading an initial 3D digital content to said distributed server, to which a respective timestamp is applied;
identifying as authors a set of users qualified to modify said initial 3D digital content, by means of data defining the respective identity of the users;
in an elaboration process of a final 3D digital content, generating a plurality of modification layers source from the initial 3D digital content, each N-th layer produced by one or more author of said set of users and provided with a respective timestamp determining a chronological order;
computing, for each generated N-th layer, a representative index of the creative contribution of the respective author based on the size of the layer, the time used to generate it and at least a rating based on the complexity of the layer;
for each N-th layer, collecting the management parameters of the layer including: the timestamp thereof, a pointer linking to a previous 3D digital content modified by the layer, an identification of the author of the layer, and said index of creative contribution;
for each generated N-th layer, assigning said management parameters to a file comprising the modified 3D digital content with all layers from 1 to (N-1)-th, together with an encoding of the N-th layer and of the management parameters obtained according to a unique cryptographic code, producing a cryptographic hash which is recorded in at least one distributed public ledger according to the blockchain technology, producing a tree structure together with the cryptographic hashes of the layers from 1 to (N-1)-th;
at the conclusion of the aforementioned elaboration process, computing the selling price and the production cost of a product obtained from the final 3D digital content in a production process, determining an added value and a share thereof to be distributed among the authors of the initial 3D digital content and of the layers added thereto; and
processing, for each author, a percentage of due share, based on the management parameters obtainable from the tree structure of cryptographic hash assigned to each layer.

2. Method of managing 3D digital contents according to claim 1, wherein the initial 3D digital content is processed by one or more authors and respective management parameters are assigned thereto, together with a cryptographic hash.

3. Method of managing 3D digital contents according to claim 1, wherein the initial 3D digital content is obtained by a 3D scanning process.

4. Method of managing 3D digital contents according to claim 1, wherein the step of processing the percentage of due share to each author takes place through an artificial intelligence algorithm.

5. Method of managing 3D digital contents according to claim 1, wherein the data defining the respective identity of a user are not accessible by other users.

6. Method of managing 3D digital contents according to claim 1, including a step wherein the proceeds related to the sale of the products are collected, and the percentages of share due to the authors are addressed to the authors as economic reward.

7. Method of managing 3D digital contents according to claim 1, wherein said at least one rating comprises an hourly wage of the respective author.

8. Method of managing 3D digital contents according to claim 1, wherein said at least one rating includes a self-assessment of the respective author.

9. Method of managing 3D digital contents according to claim 1, wherein said 3D digital content comprises a file or a set of files elaborated by a specific three-dimensional modelling software.

10. Method of managing 3D digital contents according to claim 1, wherein the initial 3D digital content is obtained by a 3D scanning process.

11. Method of managing 3D digital content according to claim 1, wherein said size of the layer produced is defined by an objective amount expressing a dimension associated with the generated layer.

12. Method of managing 3D digital contents according to claim 11, wherein said objective amount is expressed according to the amount of memory used in the process of elaborating the layer and/or the use of resources of the client device and/or the network resources used.

13. Method of managing 3D digital contents according to claim 1, wherein said size of the layer is computed by a special counter which is started subsequent to said uploading into said distributed server an initial 3D digital content and is increased each time the final 3D digital content is elaborated.

14. IT platform comprising a computer system wherein the method of managing 3D digital contents claim 1 is implemented, which is connected to a blockchain network referring to a distributed public ledger.
